(19) United States
(12) Patent Application Publication
(10) Pub. No.: US 2005/0273845 A1
(43) Pub. Date: Dec. 8, 2005

(54) Information processing device, program therefor, and information processing system wherein information processing devices are connected via a network

(76) Inventors: Akihiro Urano, Machida (JP); Takaaki Haruna, Tokyo (JP); Yumiko Sugita, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/144,797

(22) Filed: Jun. 6, 2005

(30) Foreign Application Priority Data
Jun. 7, 2004 (JP) 2004-168033

(51) Int. Cl. G06F 1/28

(52) U.S. Cl. 726/9

(57) ABSTRACT

If a notebook computer is used with its e-key device inserted in it, it is likely that the e-key device remains inserted in it even when the user carries the notebook computer. In case such notebook computer is left behind or stolen, both the notebook computer and the e-key device are lost or stolen together and it may be possible for the thief to steal information stored in the computer. When the user calls for standby, log-off, or shut-down operation, a message “remove the e-key device” is displayed on the screen and log-off or shut down is disabled until the e-key device is removed. This ensures that the e-key device is removed (when carrying the notebook computer) after log-off or shut down. The risk in which both the computer and the e-key device are stolen together is reduced overwhelmingly.

### CLAIM OF PRIORITY

The present application claims priority from Japanese application JP 2004-168033 filed on Jun. 7, 2004, the content of which is hereby incorporated by reference into this application.

### FIELD OF THE INVENTION

The present invention relates to authentication of an information processing device.

### BACKGROUND OF THE INVENTION

With growing use of notebook computers, in the event that a notebook computer is stolen, leakage of information stored in its hard disk is a problem. Techniques that disable access to data contained in the hard disk of a computer that has been stolen are being developed. For example, in U.S. Pat. No. 6,216,230, a notebook security system for preventing such information leakage is described. According to this system, a computer's hard disk serial number is encrypted and its encryption key and a User Identification Number (PIN) are stored in an electronic key device (e-key device). Unless the user inserts the e-key device into the computer and enters a valid PIN, access to data contained in the hard disk is impossible.

Using FIG. 1, let us begin with a description on transition between the power on and off states of a personal computer in relation to a state where an e-key device is inserted into the computer and a state where it is removed from the computer. FIG. 1 depicts the transition between the power on and off states of a personal computer in relation to a state where an e-key device is inserted into the computer and a state where it is removed from the computer, wherein the power on and off states of a personal computer are represented on the ordinate and whether or not the e-key device is inserted is represented on the abscissa.

Reference numeral 101 denotes a state where the computer's power is off and the e-key device is removed from the personal computer. Typically, the state 101 is the state where the user does not use the personal computer. In this sate, even if the personal computer is stolen, the thief cannot use it because there is no e-key device. That is, the personal computer can be said to be placed in a secure state. A state 103 is the state where the personal computer is powered on and the e-key device is inserted into it. Typically, the state 103 is the state where the personal computer has become ready for being operated by the user or the personal computer is in a normal operating state after an authentication process at boot-up is completed. Normally, the user of the personal computer powers on the computer and inserts the e-key device into the computer, thereby making the personal computer read for being operated. That is, transition from the state 101 to a state 102 where the computer's power is on, but the e-key device is removed from the personal computer and to the state 103 occurs.

Here, let use consider a state 104 where the computer's power is off, but the e-key device is inserted into the personal computer. By turning the computer's power on in the state 104, the computer can easily be put in the state 103; therefore, this means that it is possible for someone who is not the authenticated user to use the personal computer. As included in the above security system (U.S. Pat. No. 6,216,230), a technique in which the user is prompted to enter the PIN or password when transition from the state 104 to the state 103 occurs has been developed, but the security level as far as this transition phase is concerned is just as strong as the password and incomparably weaker than the robust security provided by using the e-key device. Therefore, the state 104 is very dangerous and it must be definitely avoided that the computer be stolen in this state.

In the above security system (U.S. Pat. No. 6,216,230), for instance, if a notebook computer and its e-key device are stolen together, there is a possibility that the encrypted hard disk protection is defeated only by guessing the PIN, resulting in information leakage. Particularly, if the user routinely uses his or her notebook computer with the e-key device inserted in it, there is a probability that the user carries the notebook computer as the e-key device remains inserted in it and the risk of information leakage in the event that the computer is stolen would not be low. This means that the computer often remains in the state 104 when the user does not use it and, if it is stolen when being in the state 104, it will easily be put into the state 103, and thereby the thief can access the data in the computer.

In a system where a personal computer interacts with a remote computer after its user is authenticated by way of the e-key device inserted in it, if the user disconnects his or her computer from the system, but the e-key device remains inserted in the computer, it will be possible for someone else to log into the system and access a remote computer fraudulently. Among systems of this kind, some system has a security mechanism in which one who is logging into the system is prompted to enter a password to prevent fraudulent access. Notwithstanding, the system is still vulnerable because the password-based security is weaker than security of authentication based on e-key.

### SUMMARY OF THE INVENTION

To prevent a computer from being stolen in the state 104, it is a best method to design a system so that transition to the state 104 does not occur. In particular, when the user tries to power down the computer with the e-key device inserted, causing transition from the state 103 to the state 104, a program leads the user to transition to the state 102 by prompting the user to remove the e-key device. The program leads the user to transition from the state 103 to the state 102 and to the state 101 and, consequently, induces the user to avoid transition to the state 104. Specifically, when the user tries to log off the notebook computer, the notebook computer instructs the user to remove the e-key device and stops the log-off process until the e-key device is removed. This ensures that the e-key device is physically separated from the notebook computer when the computer is carried. As a result, the risk in which both the notebook computer and the e-key device are stolen decreases and therefore, the risk of information leakage is reduced.

As another solution means, the log-off process of the notebook computer is programmed to start by removing the e-key device from the computer. That is, when the user logs off the personal computer, the log-off process is not initiated by a command via a keyboard or a mouse or turning the power switch off; instead, it is started by the event that the user removes the e-key device from the computer and, then, the computer will be logged off automatically. This ensures that the e-key device is removed from the computer when the computer is not in use.

Moreover, minimizing the time during which the computer remains in the state 104 is useful for preventing the theft of the computer. That is, when transition from the state 101 to the state 104 occurs, transition to the state 103 is immediately caused to occur so that the computer remains in the state 104 for as short time as possible. Specifically, when the user tries to start using the computer, if the e-key device is inserted into the computer with the power being off, the notebook computer detects that the e-key device has been inserted into the computer and automatically starts its boot-up process, thus causing transition to the state 103.

Although the above description concerns the notebook computer security, it is needless to say that the same technique can be applied to notebook computers, but also diverse types of computers such as desktop computes, server computes, PDA, and mobile phones.

Moreover, a security feature for the system where a personal computer can interact with a remote computer (hereinafter referred to as a server) after its user is authenticated by way of the e-key device inserted in it will be described below.

When a personal computer is powered on and off and when the e-key device is inserted to the computer and removed from the computer, the event is notified to the server. The server monitors the personal computer as to whether its power is on or off and whether the e-key device is inserted or removed. In particular, the server monitors for the state where the computer's power is off, but the e-key device remains inserted in it. In this state, when someone other than the authenticated user tries to log into the system, he or she can do only by entering a correct password, and this situation is dangerous. When the computer's power is turned on from the state where the computer's power is off, but the e-key device remains inserted in it, the server authenticates the user by more robust authentication than usual, e.g., prompting the user to enter a second password in addition to the normal password and duplicated authentication in combination with another authentication means such as biometrics, thereby preventing someone other than the authenticated user from logging into the system.

According to the present invention, when the user carries a notebook computer or in a situation where the user leaves the notebook computer with the power being off, it is ensured that the e-key device is separated from the computer. Thus, the risk in which both the computer and the e-key device are stolen is reduced largely. Consequently, the system security is enhanced.

### BRIEF DESCRIPTION OF THE DRAWINGS

FIG. 1 depicts the transition between the power on and off states of a personal computer in relation to a state where an e-key device is inserted into the computer and a state where it is removed from the computer, wherein the power on and off states of a personal computer are represented on the ordinate and whether or not the e-key device is inserted is represented on the abscissa, including notification of transition from the power off state to the power on state with the e-key device removed, notification of transition from the power on state to the power off state with the e-key device removed, notification of transition from the state where the e-key device is removed to the state where the e-key device is inserted with the power being on, notification of transition from the state where the e-key device is inserted to the state where the e-key device is removed with the power being on, notification of transition from the power on state to the power off state with the e-key device inserted, and notification of transition from the power off state to the power on state with the e-key device inserted.

FIG. 2 is a schematic showing a notebook computer and an e-key device.

FIG. 3 is a block diagram to explain an example of the internal structure of the notebook computer.

FIG. 4 is a block diagram to explain an example of the internal structure of the e-key device.

FIG. 5 is a flowchart illustrating a log-off procedure according to Embodiment 1.

FIG. 6 is a display screen example in which an alert message to remove the e-key device is displayed, involved in Embodiment 1.

FIG. 7 is a flowchart illustrating a log-off procedure according to Embodiment 2.

FIG. 8 is a flowchart illustrating a procedure for preventing the computer from entering the power off state with the e-key inserted when the user starts to use the computer according to Embodiment 3.

FIG. 9 is a flowchart illustrating another procedure for preventing the computer from entering the power off state with the e-key inserted when the user starts to use the computer according to Embodiment 3.

FIG. 10 depicts a topology of connection of personal computers to a server.

FIG. 11 is a block diagram to explain an example of the internal structure of the server involved in Embodiment 4.

FIG. 12 is a flowchart illustrating a boot-up procedure according to Embodiment 4.

FIG. 13 is a flowchart of a log-off procedure when powering down the personal computer according to Embodiment 4.

FIG. 14 is a flowchart of server operation when receiving a notification from a personal computer, which is a flowchart of general server operation when receiving a notification.

FIG. 15 is a flowchart of server operation when receiving a notification from a personal computer, which is a flowchart illustrating an example of server operation when receiving a power on notification.

FIG. 16 is a flowchart of server operation when receiving a notification from a personal computer, which is a flowchart illustrating an example of server operation when receiving a power down notification.

FIG. 17 shows an example of table in which the statuses of personal computers under the management of the server from the past up to now are registered.

FIG. 18 shows an example of a table listing the current statuses of the personal computers under the management of the server.

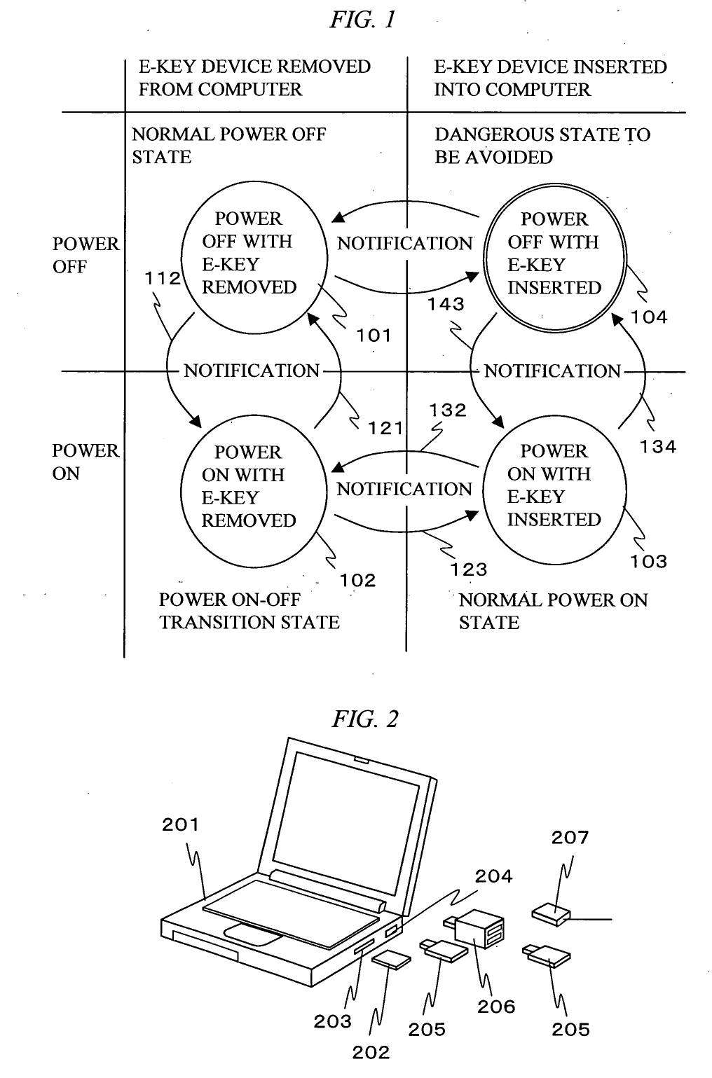

### DESCRIPTION OF THE PREFERRED EMBODIMENTS

Before describing embodiments of the present invention, a typical personal computer construction and an example of an e-key device to which the present invention is effectively applied is described.

FIG. 2 is a schematic showing a notebook computer 201 and an e-key device 202. The notebook computer 201 has a receptacle port 203 for connecting the e-key device 202 to it and the e-key device 202 can be attached to the notebook computer 201. In this example, the receptacle port 203 is a slot hole and the e-key device 202 can be attached to the computer by inserting it into the slot. In this style, after the e-key device is attached, no part of it protrudes from the side surface of the notebook computer 201. As peripheral devices of attachment type like this, PCMCIA cards, Compact Flash (a registered trademark) cards, smart media, memory sticks, etc. are known. Of course, a dedicated connection port for the e-key device may be provided. Besides, an e-key device that protrudes when attached to the computer is also available. As peripheral devices of attachment type like this, USB memory-like e-key devices and e-key devices to be inserted in a PS/2 port are known. By similar technology, an e-key device can be connected to the computer using a LAN port.

Reference numeral 204 denotes a LAN port. A type of e-key device 205 is directly inserted into the LAN port 204. Alternatively, an adapter 206 may be inserted into the LAN port 204 and the above e-key device 202 may be inserted into the adapter 206. In this case, the adapter 206 also has a socket for plug-in of a LAN cable jack 207. As will be described later, by using the LAN port, a system in which a computer is powered up only by inserting the e-key device into it from the power off state by Wake on LAN (a registered trademark) (Wake on LAN is a power up technique via a network) can be built.

When the notebook computer user (hereinafter referred to as the user) powers up the notebook computer 201 and inserts the e-key device 202 into the receptacle port 203, the user authentication is performed and then the user can use the notebook computer. Alternatively, when the user powers up the notebook computer 201 and inserts the notebook computer 201 into the receptacle port 203, an authentication prompt screen is displayed on the screen of the notebook computer. The user enters authentication information such as a password or passphrase from an input device such as a keyboard and a mouse. Or the authentication process is performed with biometrics such as a fingerprint, venous pattern, retina pattern, or voice pattern. Only after being thus authenticated, the user can use the notebook computer.

When the user is going to log off the notebook computer 201, the user enters a log-off command with the input device 307. Typically, the log-off command is issued by entering a string “logout” from the keyboard or by clicking on “start,” “log-off option,” and “power off” on the display screen in this order with the mouse. The notebook computer 201 receives the log-off command from the user and starts the log-off process.

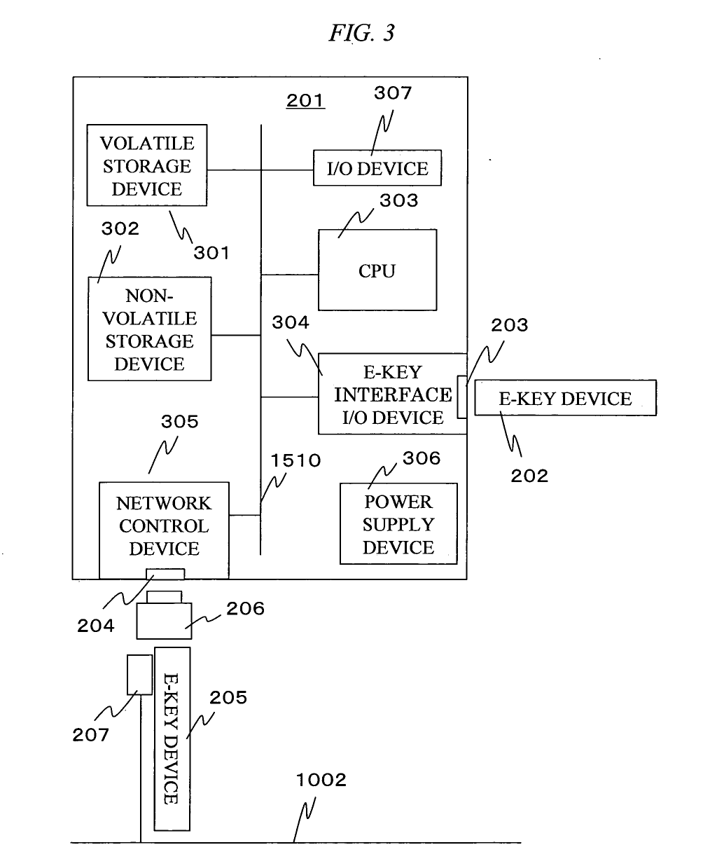

FIG. 3 is a block diagram to explain an example of the internal structure of the notebook computer 201. The notebook computer comprises a volatile storage device 301, nonvolatile storage device 302, CPU 303, e-key interface I/O device 304, network control device 305, and I/O device 307 and these components are interconnected by a system bus 1510. The notebook computer also includes a power supply device 306 that supplies necessary power to the components. Programs stored in the volatile storage device 301 or nonvolatile storage device 302 are interpreted and executed by the CPU 303. The user enters necessary information to the personal computer or gets information displayed via the I/O device 307. The CPU 303 exchanges information with the e-key device 202 via the e-key interface I/O device 304. The adapter 206 is inserted into the LAN port 204 of the network control device 305. The LAN cable jack 207 is plugged into one socket of the adapter 206 for connecting the LAN cable jack 207 and the e-key device 205 is inserted into the other socket for connecting the e-key device 205. Then, the CPU 303 can exchange information with the e-key device 205 via the network control device 305. The LAN cable jack 207 is connected to a network 1002 and connected to another notebook computer 201 or a server 1303.

The power supply device 306 performs power on/off control for all components in the notebook computer; for instance, it can control power supply such that power supply to only the network control device 305 and the e-key interface I/O device 304 is always on and power supply to other devices are turned off.

The e-key interface I/O device 304 and the network control device 305 are connected to the power supply device 306 and can give a command to power on or off the components.

In a possible arrangement, the e-key interface I/O device 304 is equipped with a physical electric switch. When the e-key device 202 is inserted, this electric switch is turned on and power is supplied from the power supply device 306 to the e-key interface I/O device 304. Also, the e-key interface I/O device 304 is equipped with an electronic sensor. By feeding electricity to only the network control device 305 and the e-key interface I/O device 304 even when the computer's power is off, it can be detected that the e-key device has been inserted even in the power off state of the computer. Upon the detection of that, power is supplied from the power supply device 306 to all components of the computer.

The I/O device 307 possibly comprises, but not limited to, a keyboard and a mouse as input devices and a display as an output device. Other devices that can function as user interfaces may be used. For example, a fingerprint image capturing device, a venous pattern reader, a voice input device, etc. are also possible as input devices; an audio output device using a speaker or the like is also possible as an output device.

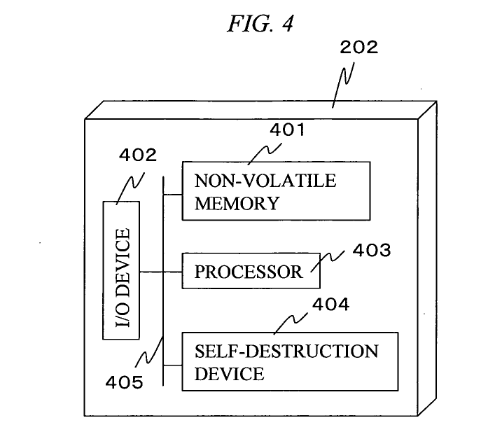

FIG. 4 is a block diagram to explain an example of the internal structure of the e-key device 202. The e-key device comprises a nonvolatile memory 401, I/O device 402, processor 403, and self-destruction device 404. An encryption key that is used to encrypt and decrypt communication and the computer's storage and user authentication information are stored in the nonvolatile memory 401. The components are interconnected by a system bus 405. When the e-key device 202 is inserted into the port 203 of the notebook computer 201, the I/O device 402 is coupled to the I/O device 304 of the notebook computer 201, the CPU 303 of the notebook computer 201 exchanges necessary information with the processor 403, and an e-key authentication process is performed. As the result of the authentication process, after the e-key device is validated, a user authentication operation may be performed by prompting the user to enter a password with the I/O device 307. In a possible implementation, if the user has entered incorrect passwords more than a specified number of times, for example, the self-destruction device 404 works so that the e-key device can no longer be used.

### Embodiment 1

In Embodiment 1, by using the above personal computer and e-key device, when the user tries to power down the computer with the e-key device inserted, causing transition from the state 103 to the state 104, a process that leads the user to transition to the state 102 by prompting the user to remove the e-key device is executed.

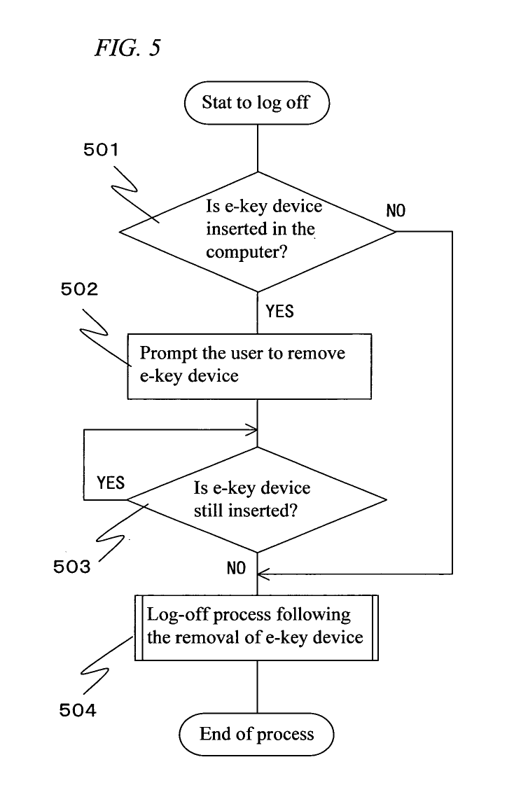

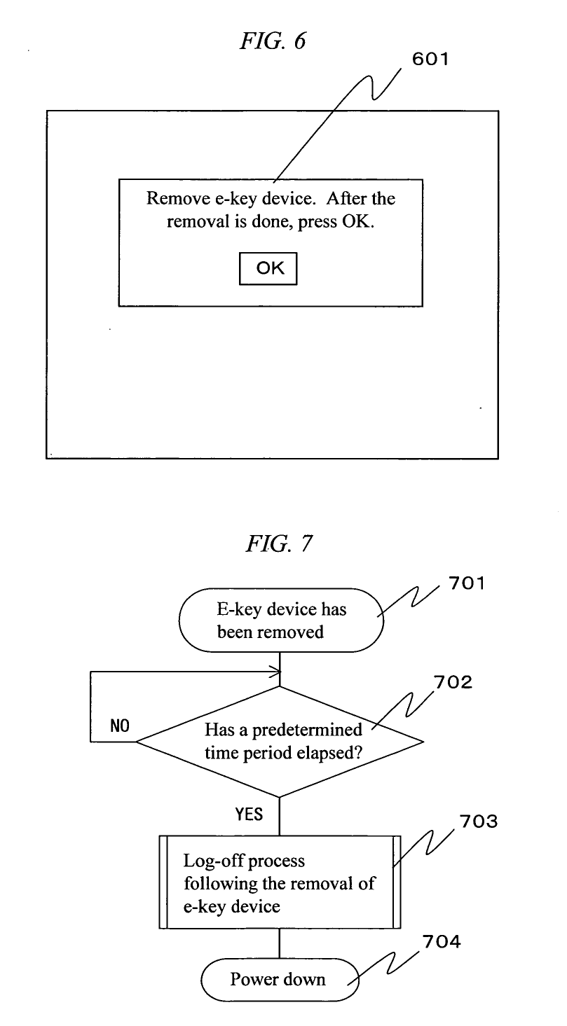

FIG. 5 is a flowchart illustrating a log-off procedure according to Embodiment 1. When commanded to execute a log-off by the user, the notebook computer starts the log-off procedure and checks whether the e-key device is inserted in the computer (step 501). If the e-key device was removed from the computer beforehand, the procedure jumps to step 504. If the e-key device is inserted, the computer prompts the user to remove the e-key device (step 502). At this time, prompting the user is carried out, for example, by displaying an alert message 601 to remove the e-key device on the screen like a display screen example illustrated in FIG. 6. Alternatively, prompting the user to remove the e-key device may be carried out by any one of or a combination of two or more methods below: presenting a graphic display to remove the e-key device on the screen; giving a voice directive to remove the e-key device; simply sounding a buzzer to alert the user to remove the e-key device; equipping the e-key device with a light emitting device and giving a light indication to remove the e-key device; equipping the e-key device with a display and displaying a message to remove the e-key device; and equipping the e-key device with a ringer device and ringing a sound to alert the user to remove the e-key device.

In a possible implementation, after the computer prompts the user to do so by displaying the alert message 601 in step 502, it waits for a response from the user indicating that the user will remove the e-key device soon; typically, the user enters OK in the alert message with the I/O device 307. In another possible implementation, the computer only displays the message “remove the e-key device” and proceeds to step 503 without regard to whether or not the response has been entered from the I/O device 307. Or the computer may stay at step 502 for a certain period of time (for example, 5 seconds) before proceeding to step 503.

In step 503, the computer checks whether the e-key device has been removed from it. If the e-key device is not removed, the computer repeats the step 503. Instead of repeating the step 503, the computer may return to the step 502 and prompt the user to remove the e-key device again, though this is not shown. At this time, a prompting method chosen from the above-mentioned methods may be repeated or another method may be used to alert the user more strongly. For example, the computer may initially display the alert message 601 on the screen to prompt the user to remove the e-key device and then, if the e-key device is still inserted, prompt the user to do so by a voice directive in addition the displayed message.

Eventually, when the e-key device is removed from the computer by the user, the computer proceeds to step 504 where the computer performs the log-off process following the removal of the e-key device (including, for example, shutting down applications, saving data to the hard disk, and instructing a device connected to the computer to execute termination processing). Then, upon the completion of the log-off process, the computer is powered down.

Although how the computer is powered down was described in this example, the same technique can also be applied when the computer enters a so-called standby state in which the CPU and peripheral devices are powered off to reduce the battery power consumption, while the power supply to the memory remains on, or even when a so-called hibernation feature is applied in which data in a volatile storage medium or on the main memory is saved to a nonvolatile storage medium before the computer is powered down so that a process that was being executed just before the power down can be continued when the computer is powered up again. This shall apply hereinafter.

In Embodiment 1, the CPU 303 can know that the e-key device has been removed from the computer in various ways. For example, the above physical electric switch provided in the e-key interface I/O device 304 is turned off by the removal of the e-key device 202 and the CPU 303 detects the turn-off of this switch. Or a noncontact sensor detects the removal of the e-key device 202 and signals this event to the CPU 303. Or the CPU 303 may detect the removal of the e-key device by disconnection of communication with the processor 403 of the e-key device 202.

According to Embodiment 1, the log-off process is not completed until the user removes the e-key device from the computer. Thus, powering down the computer and leaving the computer without removing the e-key device from it, that is, transition to the state 104 can be prevented.

### Embodiment 2

In embodiment 2, by using the above personal computer and e-key device, if the user removes the e-key device before a log-off, a process that forcedly puts the computer into the state 101 is executed.

FIG. 7 is a flowchart illustrating a log-off procedure according to Embodiment 2. Activated by an even that the user removes the e-key device, this procedure starts (step 701). As the result of the removal of the e-key device by the user, transition from the state 103 to the state 102 occurs. When the CPU 303 detects the removal of the e-key device 202, it waits until a predetermined time period has elapsed (step 702) to check whether the user has proceeded to the next operation and, then, performs the log-off process following the removal of the e-key device (step 703). Proceeding to step 704, the computer is powered down. Inconsequence, transition from the state 102 to the state 101 occurs. That is, if the user removes the e-key device before a log-off, the process that forcedly puts the computer into the state 101 is executed and, thus, the computer can be placed in the safest state. In some preferred implementation, the step 702 is dispensed with.

In this case, the log-off process following the removal of the e-key device includes executing a saving process provided in the computer just in case of unexpected stop of operation due to power disruption or the like to save text or other information that is being created in the personal computer, but is not saved properly.

In this relation, the same technique can be used when the computer is put into the standby state or hibernation state instead of being powered down, as in Embodiment 1.

### Embodiment 3

Since the system is vulnerable in the state 104 as described above, the procedures for preventing the computer from entering the state 104 during the log-off process commanded by the user were described in Embodiment 1 and Embodiment 2. In Embodiment 3, procedures for preventing the computer from entering the state 104 when the user starts to use the computer are described. That is, a system that avoids a long stay of the computer in the state 104 to prevent the user from powering on and booting up the notebook computer after the user just inserts the e-key device into the computer is described. Even if the e-key device is inserted with the computer's power being off, causing transition from the state 101 to the state 104, by putting the computer into the state 103 as soon as possible, this system is intended to prevent the computer from staying long in the state 104.

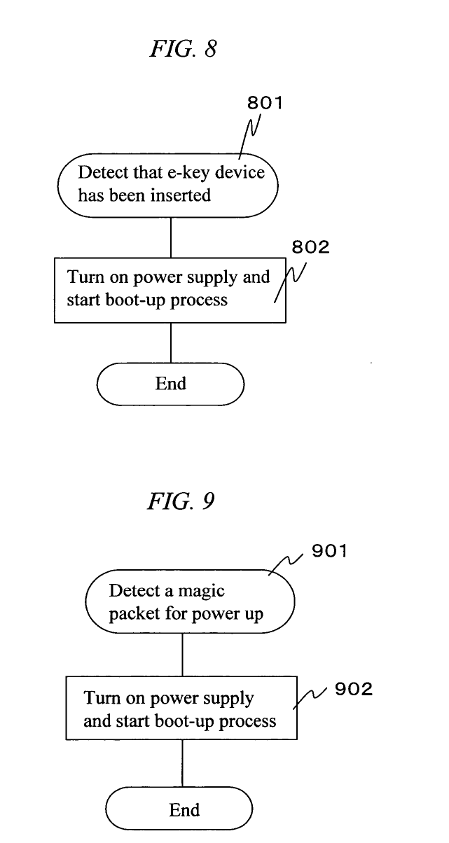

FIG. 8 is a flowchart illustrating a procedure for preventing the computer from entering the state 104 when the user starts to use the computer. When the e-key device is inserted with the computer's power being off, the e-key interface I/O device 304 detects that the e-key device has been inserted (step 801), instructs the power supply device 206 to power on the CPU 303 and other components, thus initiating a boot-up process (step 802).

FIG. 9 is a flowchart illustrating another procedure for preventing the computer from entering the state 104 when the user starts to use the computer according to Embodiment 3. If the notebook computer is provided with the LAN port 204 and the Wake on LAN function, the e-key device 205 and the adapter 206 that is inserted into the LAN port 204 is provided with a function to generate a magic packet. Consequently, when the e-key device 205 is inserted into the LAN port 204 or the adapter 206, the e-key device 205 generates a magic packet and the network control device 305 detects the magic packet (step 901). Accordingly, the network control device 305 instructs the power supply device 306 to power on the CPU 303 and other components, thus initiating the boot-up process (step 902).

According to Embodiment 3, immediately after the transition from the state 101 to the state 104 in consequence of that the user inserts the e-key device into the notebook computer 201, the computer is automatically booted up and forcedly put into the state 103. Thus, a long stay of the computer in the state 104 can be prevented and the risk in which the notebook computer encounters a theft in the state 104 can be minimized.

### Embodiment 4

Next, application of the present invention to personal computers that are connected to a remote computer (hereinafter referred to as a server) via a network is described.

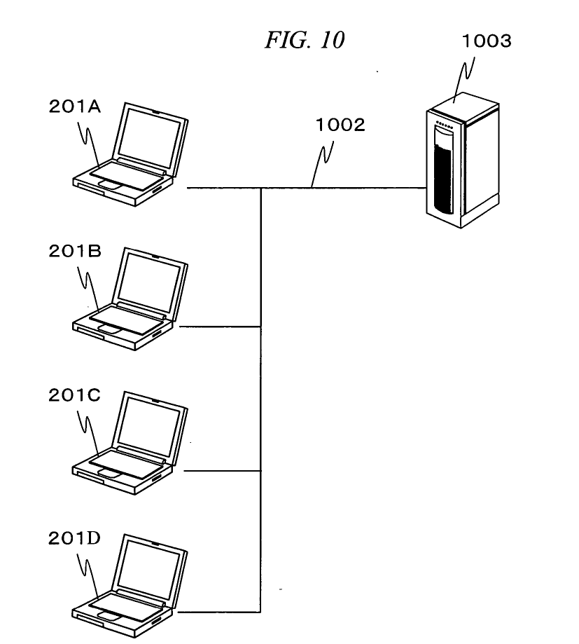

FIG. 10 depicts a topology of connection of the personal computers to the server. Computers 201A to 201D may be considered the same ones as the notebook computer 201 described with FIG. 2. The notebook computers 201A to 201D are connected to the server 1003 via the network 1002. Although the network 1002 in which elements are connected in a tree form is illustrated here, a network in which elements are connected in a ring form is also applicable.

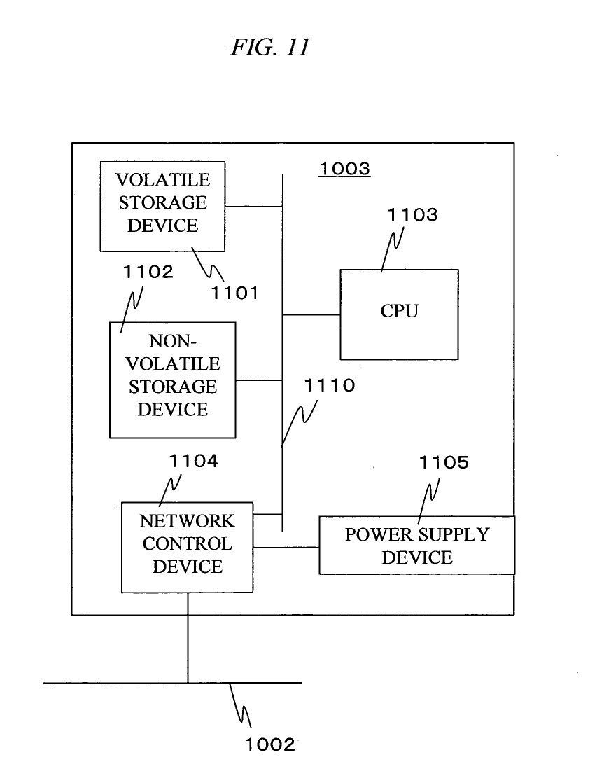

FIG. 11 is a block diagram to explain an example of the internal structure of the server involved in Embodiment 4. The server comprises a volatile storage device 1101, nonvolatile storage device 1102, CPU 1103, network control device 1104, and power supply device 1105 and these components are interconnected by a system bus 1110. The power supply device 1105 supplies necessary power to the components. The network control device 1104 is connected to the network 1002 and exchanges information with each personal computer that is connected to the network 1002 and put under management of the server. Programs stored in the volatile storage device 1101 or nonvolatile storage device 1102 are interpreted and executed by the CPU 303.

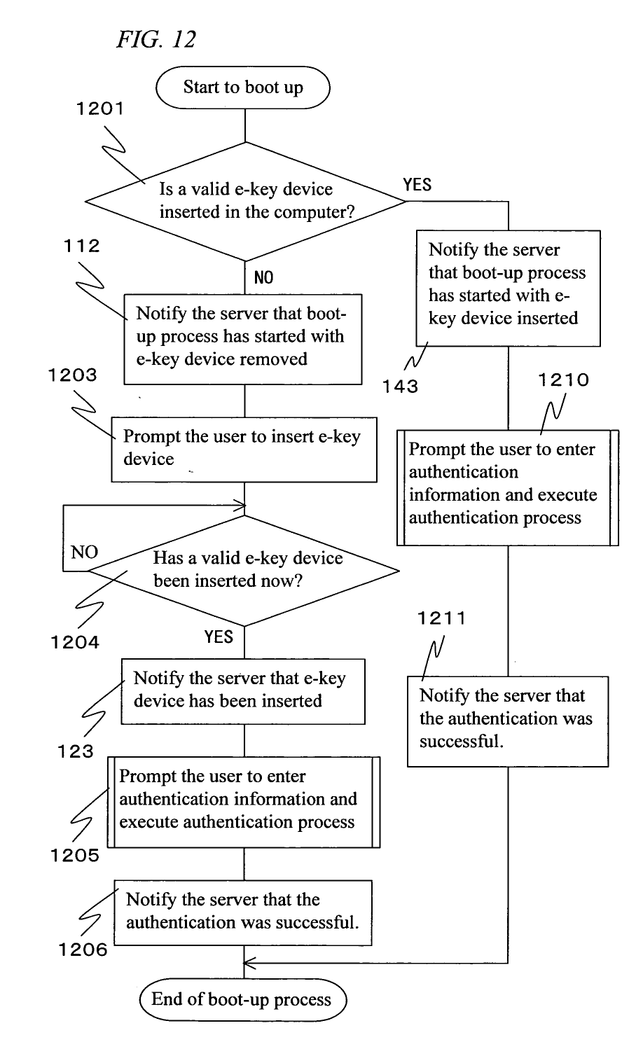

FIG. 12 is a flowchart illustrating a boot-up procedure according to Embodiment 4.

When the boot-up procedure is started, that is, the notebook computer 201 is powered up, transition from either the state 101 or the state 104 to the state 102 or the state 103 occurs. In step 1201, the computer detects whether the e-key device is inserted into it. According to the result hereof, the computer can determine a boot-up from the state 101 or a-boot-up from the state 104.

If a valid e-key device is not inserted as determined by the step 1201, the computer notifies the server that the boot-up process has started with the e-key device removed from it (step 112). The notification in the step 112 corresponds to “notification” assigned the same reference number, shown in FIG. 2. The same shall apply to reference numbers identifying notifications associated with state transition hereinafter. The wording “valid e-key device” refers to an e-key device validated by an authentication process that is performed by the personal computer, using information stored in the computer or information stored in the server or an e-key device validated by an authentication process that is performed by the server. In the latter case, the server uses information stored in it and retrieves e-key device information through the personal computer. This validation is performed through information exchange among the CPU 303 of the personal computer, the CPU 1103 of the server, and the processor 403 of the e-key device. Next, the computer prompts the user to insert the e-key device (step 1203) and waits until the e-key device is inserted (step 1204). After the e-key device is inserted, the computer notifies the server that the e-key device has been inserted (step 123). Then, the computer proceeds to step 1205.

When starting the step 1205, the computer is put into the state 102, but user authentication is not performed. The computer performs user authentication, using authentication information such as a password or passphrase (including authentication with a one-time password) entered through the I/O device 307 or by a method using biometrics such as a fingerprint, venous pattern, retina pattern, or voice pattern (step 1205). After the user is authenticated successfully, the computer notifies the server that the authentication was successful (step 1206). Then, the computer terminates the boot-up process. At this stage, the notebook computer 201 is put into the state 103. If the user is authenticated by the insertion of a valid e-key device, the steps 1205 and 1206 may be dispensed with.

If a valid e-key device is inserted as determined by the step 1201, that is, transition from the state 104 to the state 103 occurs, the computer notifies the server that the boot-up process has started with the valid e-key device inserted (step 143). Then, the computer performs authentication in step 1210, where the same authentication may be performed as the normal authentication process in the step 1205; however, it is preferable to perform stricter authentication than the authentication in the step 1205. This is because there is a possibility that a fraudulent user tries to boot up the notebook computer 201 in view of transition from the state 104 when the step 1210 is performed. In the case of transition from the state 104 to the state 103, the computer becomes ready for being operated without undergoing the authentication process by e-key. Therefore, the computer is considered vulnerable in security as compared with normal boot-up operation in which transition from the state 101 to the state 102 and to the state 103 takes place. Thus, for the computer entered the state 103 from the state 104, it is desirable to apply more robust authentication than the normal authentication with a password or the like. Specifically, more robust authentication can be carried out by using two ore more authentication schemes in combination, which may be singly performed in the step 1205, combining the normal authentication with authentication with biometrics such as a fingerprint, venous pattern, retina pattern, or voice pattern, or using a second password different from a password that is used normally. Additionally, the computer may display a message “be sure to remove the e-key device before a power down from the next time” before or after the step 1210, though this is not shown.

When the user is authenticated successfully in the step 1210, the computer notifies the server that the authentication was successful in step 1211 and terminates the boot-up process.

Through this procedure, the server 1303 can obtain information about sequential steps of the boot-up process of the personal computer 20.1. Therefore, in the case of transition from the state 104 to the state 103, the server that was notified that the authentication was successful in the step 1211, by way of caution, can report a computer boot-up with the transition from the state 104 to the state 103 to the manager of the server or the system and alert the manager to checking for fraudulent use.

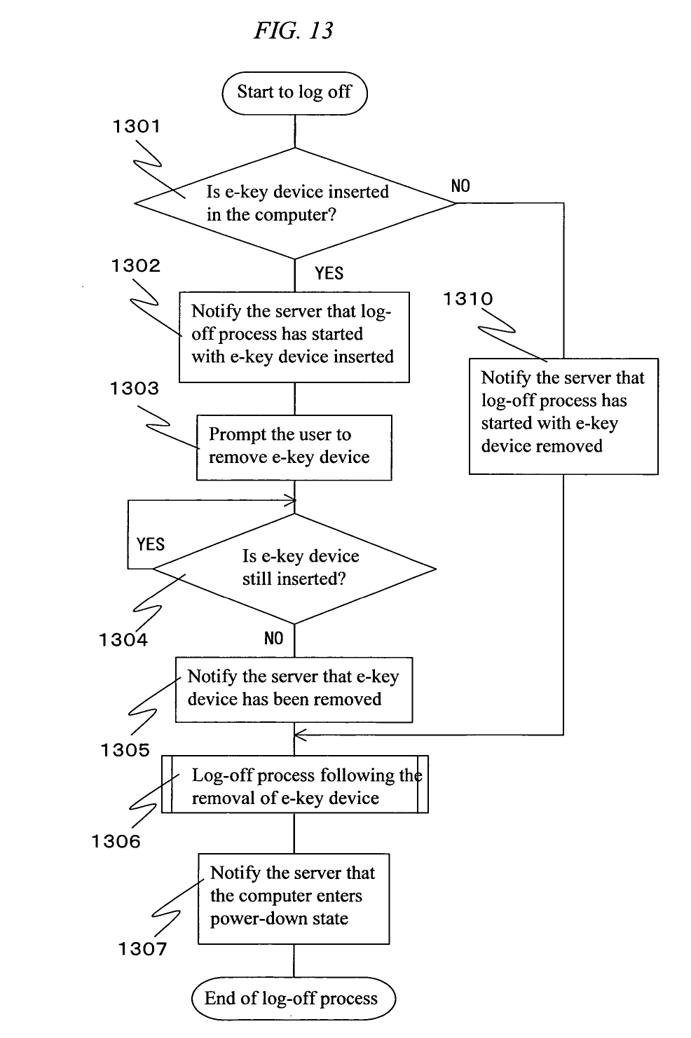

FIG. 13 is a flowchart of a log-off procedure when powering down the personal computer according to Embodiment 4.

In the same way as the log-off command input to the personal computer in Embodiment 1, when the user starts to log off the notebook computer, in response to the input of the log-off command, the computer checks whether the e-key device is inserted in it (step 1301). If the e-key device is inserted, the computer notifies the server that the log-off process has started with the e-key device inserted (step 1302). Then, the computer prompts the user to remove the e-key device (step 1303) and waits until the e-key device is removed (step 1304). Execution of the steps 1303 and 1304 can be implemented in the same manner as for the steps 503 and 504 in Embodiment 1. Next, the computer notifies the server that the e-key device has been removed (step 1305). Then, the computer proceeds to step 1306.

On the other hand, if the e-key device is not inserted as determined by the step 1301, the computer notifies the server that the log-off process has started with the e-key device removed (step 1310). Then, the computer proceeds to step 1306.

In the step 1306, the computer performs the log-off process following the removal of the e-key device. This process is the same as for the step 504 in Embodiment 1. Following this process, the computer notifies the server that the computer enters the power-down state (step 1307).

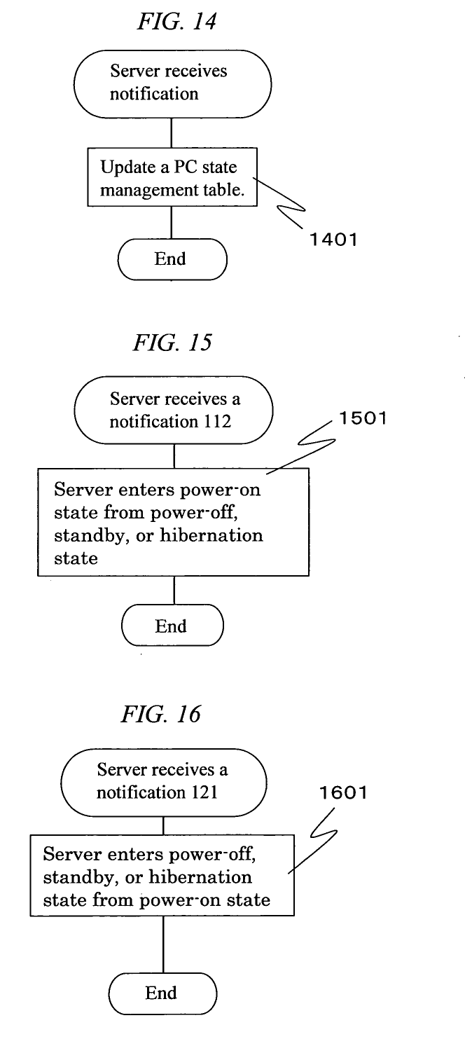

FIG. 14 is a flowchart of server operation when receiving a notification from a personal computer. This is a flowchart of general server operation when receiving a notification.

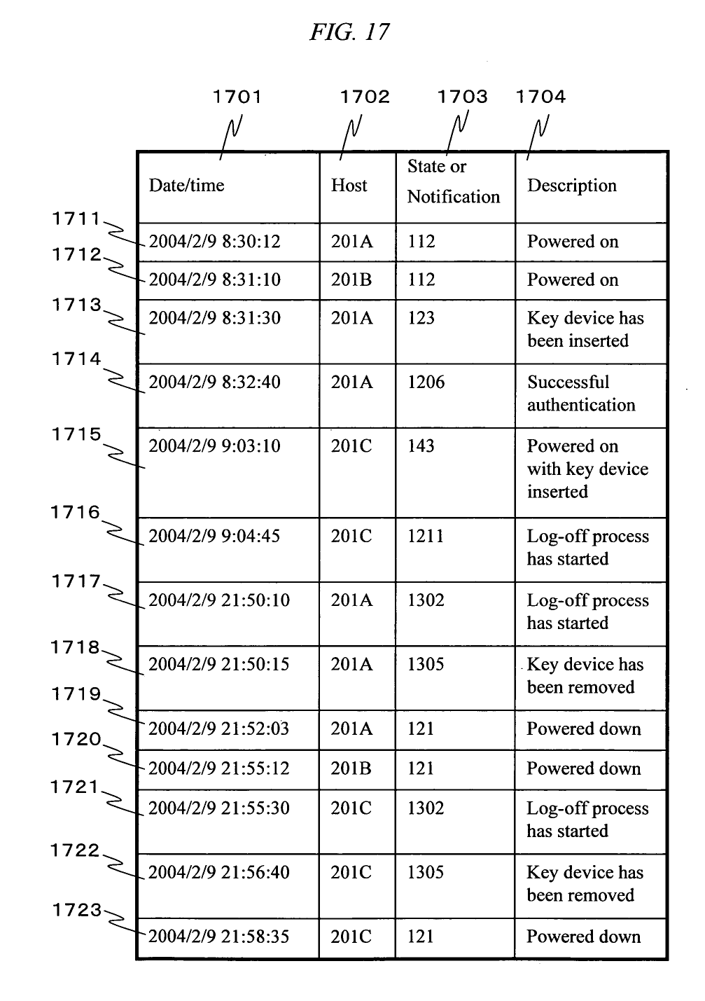

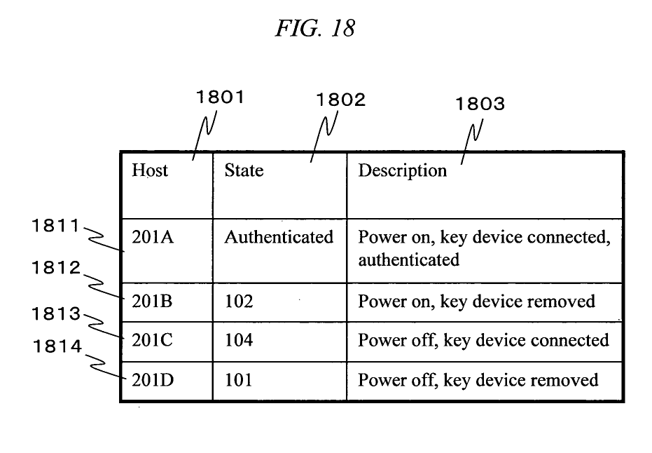

As FIG. 14 indicates, when the server receives a notification from a personal computer, the server registers the notification contents into a management table whose example is shown in FIG. 17 or FIG. 18 (step 1401).

In a possible implementation of this embodiment, the server is powered on and off in concurrence with the power on and off of a notebook computer. This can be implemented as follows.

FIG. 15 and FIG. 16 are flowcharts of server operations when receiving a notification 112 and a notification 121 from a personal computer, respectively. FIG. 15 is a flowchart illustrating an example of server operation when receiving the notification 112. FIG. 16 is a flowchart illustrating an example of server operation when receiving the notification 121.

Upon receiving the notification 112, as FIG. 15 indicates, the server operates to enter the power-on state from the power-off, standby, or hibernation state (step 1501). Then, the server performs operation described in FIG. 14. Upon receiving the notification 121, the server performs operation described in FIG. 14 and then operates to enter the power-off, standby, or hibernation state from the power-on state (step 1601), as FIG. 16 indicates. In this relation, selection of the power-off, standby or hibernation state that the server will enter may be defined by the user or the manager of the server or the server may send a query to the user so that one of the above states is determined by the user each time of power down and the user may select one of the above states appropriately.

FIG. 17 shows an example a table in which the statuses of personal computers under the management of the server from the past up to now are registered. This table may have the following columns: date/time 1701, host name (personal computer name under the management of the server) 1702, state or notification 1703, and description 1704 on the state 1703. In this example of the table, an entry in the state or notification column 1703 is a reference number assigned to a device, state, or notification shown in relevant FIG. 2, FIG. 12, FIG. 13 or FIG. 10. However, it is needless to say that other state or notification labels using numbers, symbols, and the like may be used.

A record in a row 1711 states that a notification 112 that a personal computer 201A has been powered on was received at 8:30:12 AM on Feb. 9, 2004. Likewise, a record in a row 1712 states that a notification 112 that a personal computer 201B has been powered on was received. A record in a row 1713 states that a notification 123 that e-key device has been inserted was received. A record in a row 1714 states that a notification 1206 of successful authentication was received. A record in a row 1715 states that a notification 143 that a computer was powered on with e-key device inserted was received. A record in a row 1716 states that a notification 1211 of successful authentication for a personal computer 201C was received. A record in a row 1717 states that a notification 1302 that a log-off process has started on the personal computer 201A was received. A record in a row 1718 states that a notification 1305 that the key device has been removed from the personal computer 201A was received. A record in a row 1719 states that a notification 121 that the personal computer 201A has been powered down was received. A record in a row 1720 states that a notification 121 that the personal computer 201B has been powered down was received. A record in a row 1721 states that a notification 1302 that a log-off process has started on the personal computer 201C was received. A record in a row 1722 states that a notification 1305 that the key device has been removed from the personal computer 201C was received. A record in a row 1723 states that a notification 121 that the personal computer 201C has been powered down was received.

FIG. 18 shows an example of a table listing the current statuses of the personal computers under the management of the server. By way of example, FIG. 18 lists the statuses of the computers as of 9:00:00 AM on Feb. 9, 2004. The table has the following columns: host name (personal computer name under the management of the server) 1801, state 1802, and description 1803 on the state which is not always necessary.

A record in a row 1811 states that the personal computer A is in the power-on state, its e-key device is inserted in it, and authentication is successful. A record in a row 1812 states that the personal computer 201B is in the power-on state, but its e-key device is removed. A record in a row 1813 states that the personal computer 201C is in the power-off state, but its e-key device is inserted in it. A record in a row 1814 states that a personal computer 201D is in the power-off state and its e-key device is removed. Here, the state of the computer in the row 1811 can be known from the record in the row 1711 and the record in the row 1713 in the table of FIG. 17. From the statuses of the computers managed in the table of FIG. 17, their statuses as of 9:00 AM on that day down to the row 1812 can be known. The statuses of the computers in the row 1813 and the row 1814 are not present in the records in the table of FIG. 17 and these statuses are derived from the events happened at older time. Although a method of deriving the table of FIG. 18 from the table of FIG. 17 was described here, it is needless to say that the management table of FIG. 18 can be realized by updating this table each time the server receives information transmitted from any of the personal computers 201A to 201D.

The record in the row 1813 indicates that the personal computer 201C is in the state 104, that is, the computer 201C is in a dangerous state. It is desirable that the server issues warning upon detecting this state. Issuing warning may be carried out by displaying a message on the server manager's display, by giving a voice directive, or by e-mail to the manager. Besides, it may also preferable to e-mail or call the manager or the last time user of the personal computer 201C to alert him or her to the dangerous state.

Although the tables shown in FIGS. 17 and 18 are managed, involved in Embodiment 4, only the table of FIG. 17 may be used because the table of FIG. 18 can easily be created from the table of FIG. 17. If it is not required to store past statues of the computers, only the table of FIG. 18 may be managed, dispensing with the table of FIG. 17.

### Supplementary Embodiment 5

In any of the foregoing embodiments, after a valid user is authenticated with a valid e-key, the e-key device is assumed to remain inserted in the personal computer, if the computer is in use. However, because the e-key device is needed to authenticate a person who tries to use the personal computer as its proper user, it is not needed to keep the e-key device inserted in the computer during the use of the computer. Thus, once the user has been authenticated with a valid e-key and the computer booted up, the e-key device may be removed from the computer; doing this is better for avoiding transition to the state 104. To prompt the user to do so, following the step 802 in FIG. 8, the computer should display a message “remove the e-key” like an alert message exemplified in FIG. 4 and the computer operation is disabled until the e-key device is removed. Following the step 902 in FIG. 9, the computer should give caution to the user to remove the e-key device. Similarly, in the example of FIG. 12, following the authentication process in the step 1205, the computer should give caution to the user to remove the e-key device.

As described above, according to the present invention, when the user is going to log off the notebook computer, if the e-key device is inserted in the computer, the compute prompts the user to remove the e-key device and does not perform the log-off process until the e-key device is removed. Consequently, after the log-off process is performed, it is ensured that the notebook computer and the e-key device are separated physically. That is, even if the user may leave the notebook computer, it can be assured that the e-key device is removed from the notebook computer.

Having described preferred embodiments of the invention with reference to the accompanying drawings, it is to be understood that the invention is not limited to the embodiments and that various changes and modifications could be effected therein by one skilled in the art without departing from the sprint or scope of the invention as defined in the appended claims.

1. An information processing device comprising a volatile storage device, a nonvolatile storage device, a CPU, an e-key interface I/O device, an I/O device, which are interconnected by a system bus, and a power supply device,
wherein, upon detecting a log-off process of said information processing device being called for, said CPU prompts the user of the information processing device to remove an e-key device from the information processing device and inhibits execution of the log-off process until the e-key device is removed.

2. The information processing device according to claim 1, wherein the log-off process is called for by a log-off command entered by the user from the I/O device of said information processing device.

3. The information processing device according to claim 2, wherein said prompting the user is carried out by displaying a directive on the display screen of the I/O device of said information processing device.

4. The information processing device according to claim 2, wherein said directive on the display screen of the I/O device is an alert message to remove the e-key device.

5. The information processing device according to claim 4, wherein said directive on the display screen of the I/O device is accompanied by a voice or sound directive that is given in addition to and in parallel with the alert message to remove the e-key device.

6. An information processing device comprising a volatile storage device, a nonvolatile storage device, a CPU, an e-key interface I/O device, an I/O device, which are interconnected by a system bus, and a power supply device,
wherein the log-off process of said information processing device is initiated when the user removes the e-key device from said e-key interface I/O device.

7. An information processing device comprising a volatile storage device, a nonvolatile storage device, a CPU, an e-key interface I/O device, an I/O device, which are interconnected by a system bus, and a power supply device,
wherein, upon detecting that the e-key device has been inserted into said e-key interface I/O device, said CPU initiates a boot-up process of said information processing device.

8. A program for an information processing device necessary for operation of an information processing device comprising a volatile storage device, a nonvolatile storage device, a CPU, an e-key interface I/O device, an I/O device, which are interconnected by a system bus, and a power supply device, the program being stored in said nonvolatile storage device,
the program comprising the steps of prompting the user of the information processing device to remove an e-key device from the information processing device upon detecting a log-off process of said information processing device being called for and inhibiting execution of the log-off process until the e-key device is removed.

9. The program for the information processing device according to claim 8, wherein said program detects the log-off process of the information processing device being called for by a log-off command entered by the user from the I/O device of said information processing device.

10. The program for the information processing device according to claim 9, wherein said program carries out said prompting the user by displaying a directive on the display screen of the I/O device of said information processing device.

11. The program for the information processing device according to claim 9, wherein said program displays an alert message to remove the e-key device as the directive on the display screen of said I/O device.

12. The program for the information processing device according to claim 11, wherein said program gives a voice or sound directive in addition to and in parallel with displaying the alert message to remove the e-key device on the display screen of said I/O device.

13. The program for the information processing device according to claim 8, wherein said program initiates the log-off process of said information processing device by detecting removal of the e-key device from said e-key interface I/O device.

14. A program for an information processing device necessary for operation of an information processing device comprising a volatile storage device, a nonvolatile storage device, a CPU, an e-key interface I/O device, an I/O device, which are interconnected by a system bus, and a power supply device, the program being stored in said nonvolatile storage device,
wherein said program initiates a boot-up process of said information processing device upon detecting that the e-key device has been inserted into said e-key interface I/O device.

15. An information processing system comprising:
one or more information processing devices, each comprising a volatile storage device, a nonvolatile storage device, a CPU, an e-key interface I/O device, a network control device, and an I/O device, which are interconnected by a system bus; and
a server comprising a volatile storage device, a nonvolatile storage device, a CPU, a network control device, and a power supply device, which are interconnected by a system bus,
said information processing devices being connected to said server through the network control devices,
wherein said each information processing device sends said server any one or more notifications corresponding to events when:
said information processing device has been powered on;
detecting that the e-key device has been inserted into said information processing device;
user authentication process has been completed on said information processing device;
detecting the e-key device has been removed; and
the user has entered a log-off command to said information processing device.

16. The information processing system according to claim 15, wherein, when said server receives a notification that said e-key device has been inserted or removed, its CPU stores the notification in place and transmits a signal to display a message to remove said e-key device to the user upon receiving a notification that a log-off process of said each information processing device has started with the e-key device inserted.

17. The information processing system according to claim 16, wherein said information processing device, upon detecting that the e-key device has been inserted beforehand at power-on, performs stricter user authentication than usual by asking for a second password or asking for authentication by two or more authentication means.

18. The information processing system according to claim 17, wherein said server, upon detecting that said information processing device has been powered down with the e-key device inserted in it, notifies the manager of that event.

19. The information processing system according to claim 18, wherein said server, upon detecting that said information processing device has been powered on with the e-key device inserted in it beforehand, notifies the manager of that event.

20. An information processing device comprising a volatile storage device, a nonvolatile storage device, a CPU, an e-key interface I/O device, an I/O device, which are interconnected by a system bus, and a power supply device,
wherein, upon completion of a process of user authentication with the e-key, said CPU prompts the user to remove the e-key device and keeps the information processing device disabled to be used by the user until the e-key device is removed.
